(19) United States
(12) Patent Application Publication
(10) Pub. No.: US 2021/0277530 A1
(43) Pub. Date: Sep. 9, 2021

(54) NEW ELECTRO-CHEMICAL PROCESS BASED ON A DIMENSIONLESS FACTOR

(71) Applicant: Alejo Ivan GALLEGOS RIEDEMANN,, Concepcion (CL)

(72) Inventor: Alejo Ivan GALLEGOS RIEDEMANN,, Concepcion (CL)

(21) Appl. No.: 17/289,738

(22) PCT Filed: Oct. 29, 2019
(86) PCT No.: PCT/CL2019/050107

§ 371 Date: Apr. 29, 2021

(30) Foreign Application Priority Data
Oct. 29, 2018 (CL) 3073-2018

(51) Int. Cl. C25C 1/12; C25C 7/06

(52) U.S. Cl. CPC C25C 1/12; C25C 7/06

(57) ABSTRACT

The invention relates to a new way of reducing dissolved metals, in particular Cu⁺² to Cu⁰, in which the effect of the diffusion-limiting layer is regulated, optimising the variables which determine the mobilisation of the metal ion (Cu+²) towards the cathode and the thermodynamic stability of the reduction reaction of Cu+² to Cu⁰ (or metal of interest) on the cathodic surface. The process is carried out by controlling a dimensionless ratio (referred to as t) or the cathodic polarisation, within certain predefined margins, dynamically adjusting concentrations, flows and/or electrical currents to maintain the predefined operating conditions at an optimum level.

This application is addressed to a new method of metal reduction from aqueous solutions, which operates by varying the feed current and electrolyte recirculation flow in such a way that stable operational conditions are maintained on the cathodic surface. Through its use, in the case of Cu, the spectrum of treatable solutions for the electro-obtaining technique is expanded at such low concentrations such as 2 gpl of Cu, and the treatment of polymetallic solutions is also allowed, with the presence of dissolved As, Sb, and Bi. Its use can be extended to the reduction of other metals, such as Ni, As, Zn, Ag, and Co.

### BACKGROUND AND STATE OF THE ART

In processes where Cu²⁺ is required to be extracted from charged electrolytes, both in mining as in the metallurgical industry, it is operated in a batch method, in which electrolytes with high concentrations of Cu²⁺ are charged to a tank that feeds a series of cells, where in an arrangement of anodes and cathodes, the following main reactions occur:

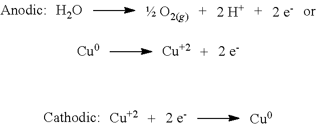

In electro-obtaining, the typical input concentrations of the electrolyte are 45 to 50 gpl of Cu⁺² and is discarded when it reaches 25-30 gpl, being sent to a Cu²⁺ recharge. Normally the electrolyte is recharged from an extraction plant for solvents, which has the function of concentrating the Cu²⁺ from the solutions coming from leaching and not allowing the passage of impurities to the electrolytic ship. In electro-refining, electrolytes with concentrations of Cu⁺² Between 40 and 50 gpl are used, which are sent to the cleaning circuits when the concentrations of Cu⁺² exceed 50 gpl and/or the contents of other impurities jeopardize the cathodic quality.

The product of these operations are copper cathodes, which have different qualities in function of the impurities present in them. It is operated under normal conditions of constant cathodic current density, in the order of 250 to 380 A/m² and the recirculation/feed flows to cells Between 10 and 30 lt/m (FIG. 1). The voltage drop (electrical potential) in each cell varies with electrolyte depletion, increasing from approximately 1.7 to 2 volts, which is due to the change in the composition of the electrolyte as the process advances. The harvest of the cathodes usually occurs after a week of operation, occasion in which they are removed for commercial market, and are replaced by new, thin and/or stem leaves.

If the condition described is analyzed, the first thing that is observed is that the industrial design is oriented to a constant production flow, given by the maintenance of the rectifier current.

On the other hand, if the advance of the main reactions is considered, both the electrolyte and the phenomenology that occur on the cathodic surface change as the process advances. The electrolyte is impoverished in Cu⁺², enriching in H⁺ and increasing its viscosity, all phenomena that hinder the forming of Cu⁰ because it decreases the presence of Cu⁺² ions on the cathodic surface, both because of the decrease of its concentration, and due to the progressively difficult transport through the boundary layer. The latter occurs early on the cathodic surface (citation 1) and defines the presence of a high cathodic polarization (qc) per concentration, condition that increases with the advance of the shift. It is then clear that the presence of the boundary layer of depletion implies:
Limitations on the speed of the process; behavior according to Tafel's law. Inefficient use of energy, due to over-polarization.
Inefficient contribution of the migratory component to the flow of Cu⁺²
Risk of cathodic contamination, by thermodynamic occlusion and/or authorization.
Operational limitations, by increasing the boundary of mean concentrations of Cu⁺² treatable by electro-obtaining.

From the perspective of cathodic polarization (ηc), FIG. 2 shows the results of a trial observing the evolution of cathodic potential (Ec) during total decobrization of a sulphuric solution, in the presence of As. The circuit has a remaining concentration of 0.5 g/l of Cu⁺² and is loaded with electrolyte with 2.5 g/l of Cu⁺². The system operated at a density of a constant electrolyte stream and flow. It is observed that the signal of Ec initially increases (mixture) to then diminish progressively to values lower than −580 mV/Cu—Cu⁺². The sequence of phenomena observed on the cathodic surface is as follows:
In the first 40 minutes, solids are formed of type Cu₃As₍ₛ₎, black, with −380 mV<Ec<−265 mV (zone 21).
Between 40 and 195 minutes, Cu⁰ is formed with −265 mV<Ec<−189 mV (zone 22).
Between 200 and 330 minutes, Cu₃As₍ₛ₎ is formed again, with −440 mV<Ec<−270 mV (zone 23).
From 330 minutes, H₃As_{(gas)} is formed intermittently, generating the detachment of the previously formed Cu₃As solids; the electrolyte darkens with the suspended particles, resulting in the phenomenon called “electrolyte burning.” The value of Ec destabilizes, decreasing and sharply increasing its value until the almost total detachment of Cu₃As solids, which occurs at 355 minutes (zone 24).
From 355 minutes onward, the stable cathodic reaction is the generation of H₃As_{(gas)}, with Ec values stabilized under −580 mV (zone 25).

It is evident that the use of different ranges of Ec allows to obtain different deposits on the cathodic surface, which was already used as a tool to define the electrolysis process of Zinc (citation 2); this concept was also used in the Window Refinery (citation 3), to co-reduce Cu⁺² and As⁺^{³} forming Cu₃As type solids, increasing the treatment capacity of the cleaning circuit by 70%, and eliminating any risk of Arsine generation. Finally, in 2014, a group of researchers led by P. Los (citation 4) reported results obtained in laboratory tests and piloting of electro-obtaining and industrial electro-refining processes of Cu, constantly maintaining different values of Ec.

On the other hand, the increasing ηc per concentration originates in the stabilization of the boundary layer on the cathodic surface, which induces to think of methodologies that mitigate its effect. In this context, the agitation of the electrolyte, that is, controlling the convective edge of the process can make it faster.

A development that considers the use of high rates of electrolyte recirculation corresponds to circular cells (citation 5). These equipment were tested for operations at Codelco, and the results were presented at the Hydro Copper 2005 International Copper Hydrometallurgies Workshop (citation 6). This study shows that the use of high rates of electrolyte recirculation (200 lt/m) allows to operate with high current densities (800 A/m²). It concludes by proposing an operation at different stages of constant current density, that is, it does not consider the possibility of adjusting the Ec or the electrolyte flow fed to the cells with as the process advances.

### BRIEF DESCRIPTION OF THE FIGURES

FIG. 1: Represents the curve of a conventional electro-obtaining system in a graph showing the depletion of the concentration of Cu⁺² at a constant current density, with the progress of the shift. The shape of a Cathodic Isopotential curve E1 is shown.

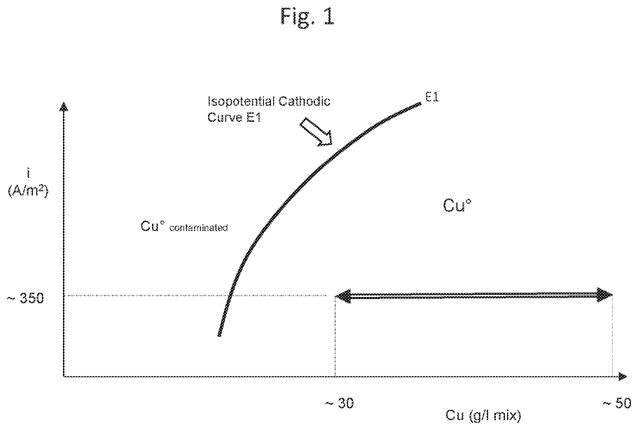

FIG. 2: Shows the evolution of cathode potential (Ec) during the electrolysis of a 2 g/l Cu⁺² solution that is fed to a circuit with 0.5 g/l. The operation is at constant current and it is observed how values both increase during mixing, and then decrease until the generation of H₃As_{(gas)}. The different stages for which the cathodic reaction passes (zones 31 to 35) are indicated, noting that they are associated with different ranks of Ec.

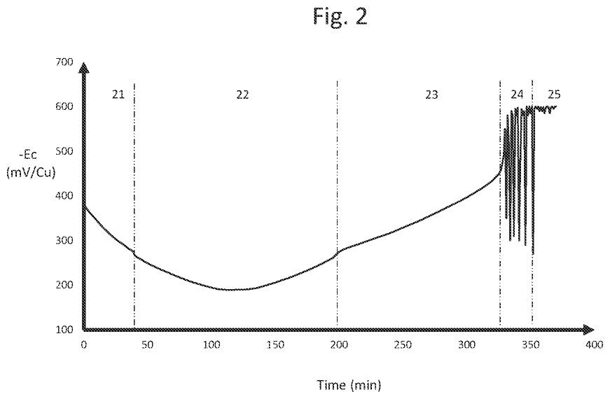

FIG. 3: Represents the effect of varying the recirculation flow of the electrolyte over the position of an isopotential curve Ec, observing possible effects to apply on the current, as well as in the possible concentrations of Cu⁺² to treat.

FIG. 4: Shows the operating plane of the proposed new process in a graph of current density versus electrolyte recirculation flow for a given polarization qc. In it, is shown several isoconcentration curves of Cu⁺², the operational range of recirculation flows and the circuit rectifier, in addition to four points (40, 41, 42 and 43) that define a polygon where for any interior point, the conditions result for the concentration of Cu⁺², the current of the rectifier and the flow of electrolyte that will allow to fulfill the ηc of the design of the graphic.

FIG. 5: Shows values of the dimensionless [symbol] proposed with results obtained in industrial tests. It is observed the existence of three operating zones and that the recovery of Cu⁰ supposes to extract no more than 6.5% of the Cu fed to the cell.

FIG. 6: Shows how the cathodic quality varies in function of the polarization qc.

FIG. 7: Shows the ratio of the dimensionless [symbol] with the cathodic quality, noting that for values less than 0.0025, it is possible to obtain grade A cathodes.

### DETAILED DESCRIPTION OF THE INVENTION

A new way of operating the reduction of dissolved metals is proposed, particularly Cu⁺² to Cu⁰, in which the effect of the diffusion boundary layer is regulated, by optimizing the variables that determine the mobilization of Cu⁺² towards the cathode and the thermodynamic stability condition of the reduction reaction from Cu⁺² to Cu⁰ (or of the metal of interest) at the cathode surface.

As explained, there is a strong depletion of Cu⁺² in the boundary layer, which causes the usual reduction process to behave as if it had decreased mean concentrations from its actual value. The nature of the boundary layer defines the speed of the process.

The Nemst-Planck equation solves the phenomenology of unidirectional ion transport, according to the relationship:

$${J ( x )}_{Flow} = - D {\frac{\partial C ( x )}{\partial x}}_{Diffusion} - {\frac{z F}{R T}}_{Migration} DC - {\frac{\partial φ ( x )}{\partial x}}_{Convection} + CV ( x )$$

In it, it is stated that the flux of an ionic species towards the cathode is determined by 3 components:
Diffusion: given by Fick's law, which considers that the concentration gradient of the analyzed species defines its mobility. It assumes that the medium does not have mechanical mobility, that is, it is the predominant transport in the boundary layer.
Migration: which considers the contribution of the electric field as a promoter of ionic flow.
Convection: which considers the contribution of mechanical mobility.

Adjusting this relationship for the case of reduction to Cu⁰, it is observed that:

Boundary layer, migratory contribution, and polarization (ηc): in the zone adjacent to the cathodic surface is the boundary layer of depletion of Cu⁺² that forces the electric field to increase to maintain productivity (migratory component). In operations, it is observed that when the polarization ac increases, the thickness of the diffusion boundary layer increases, which implies that there is a direct binding relationship between the characteristics of the diffusion layer and the ac (migratory component).

Boundary layer and convective contribution: the convective contribution is defined as the product between the instantaneous concentration of Cu⁺² and the flow of electrolyte in cathodic direction. If the Cu⁺² present on the cathodic surface is considered to be directly related to the Cu⁺² fed to the cells, then the latter is considered. Increasing the flow of Cu⁺² fed to the cells decreases the thickness of the boundary layer and increases the presence of Cu⁺² ions on the cathodic surface.

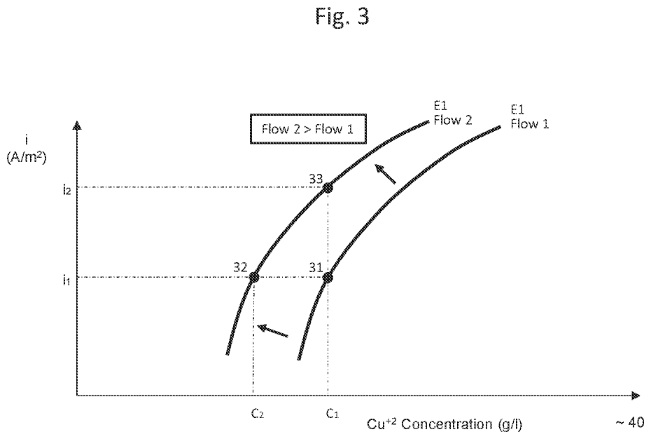

Relationship between convective input and ac: complementarily, in industrial experiences it has been observed that variations in the flow of electrolyte fed to cells, have the effect shown in FIG. 3, where it is observed that for an ηc or cathodic potential (Ec) given, an increase in flow from F1 to F2 (convective variable) allows both to operate with lower concentrations of Cu⁺² (stroke 31 to 32, concentrations of C1 to C2) as well as to increase the current fed to the circuit (stroke 31 to 33, current from i1 to i2).

Relationship between convective, migratory contributions, and the diffusion layer: What is described implies that there is a synergistic co-relationship, of voluntary use, between convective and migratory contributions in the ionic mobility, which define the characteristics of the limitation imposed by the diffusion layer.

For all of the above, it is possible to define a controlled operation with the ηc (or Ec), where the regulation of the ac is established through the management of the convective and migratory variables of the circuit.

In terms of the convective variable, ηc increases (Ec decreases) by decreasing the recirculation flow of the electrolyte, and by analogy, the rac decreases (Ec increases), increasing the recirculation flow of the electrolyte in the cell.

In terms of the migratory variable, the rac increases (Ec decreases) by increasing the cell voltage or the current circulating through it; analogically, ηc decreases decreasing the cell voltage or the current entered into the cell.

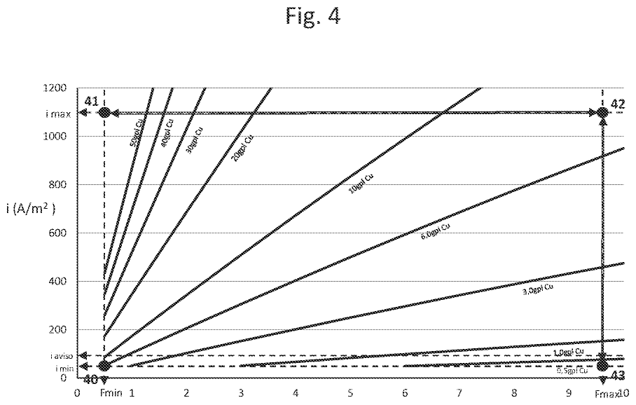

Operational plane: FIG. 4 shows a graph of electrolyte Flow v/s i (A/m²), where you can seethe plane of possible operational options with different concentrations of Cu⁺², for a potential cathodic Ec given. Any point confined to the polygon defined by 40-41-42 and 43 defines the flow condition, the concentration of Cu⁺², and the density of operational current to achieve the Ec of the design of the graphic. For the lower Ec, the slopes of the isoconcentration curves increase and similarly, the slopes are smaller for higher values of Ec.

Dimensionless quotient: A dimensionless quotient [symbol] is proposed, whose operational expression is:

$$= K * \frac{1}{\# * {F}^{*} [ M ] i}$$

Where
i: Current density (A/m²)
#: Flow partition factor, which is equivalent to the fraction of the electrolyte fed to the cell that actually circulates through the anode-cathode interface. It takes the value of 1 when all the electrolyte fed to the cells passes between anodes-cathodes (for example in a circular cell); in conventional Cu cells, it takes typical values between 0.4 and 0.7.
F: Volumetric flow of electrolyte fed to the cell (1/s)
[M] i: Instantaneous concentration of M⁺ⁿ present in the electrolyte (g/l)
K: is a constant that involves the molecular weight of M⁰, its valence, cathode dimensions, cathode-anode distance, Faraday constant, and unit adjustment factors. Its value is invariant in operations.

Operationally [symbol] allows an indirect reading of ηc (Ec), which implies that by limiting its fluctuation, ηc (Ec) is also limited. In addition, it allows to control the operation by varying flows, concentrations, or the current fed to the circuit, indistinctly, in order to maintain balanced transport and deposition conditions, stabilizing the phenomenology present on the cathodic surface.

Basic operational concept with [symbol] (example with concentration of Cu⁺²): On a circuit in operations, by reducing the concentration of Cu⁺², [symbol] increases its value; when [symbol] gets out of the ideal predefined range, corrective options will be to increase the flow of Cu⁺² and/or decrease the current fed to the circuit; analogously, during the recharge of the electrolyte rich in Cu⁺², the concentration of Cu⁺² of the circuit will increase, for that [symbol] decreases; the corrective options will be to increase the current fed to the circuit and/or diminish the flow of Cu⁺².

Industrial Implementation

1.—Equipment:

In general, equipment will be required that allows to vary flows in the cathodic surface, current in the cell and/or concentration of the metal of interest in the electrolyte, according to an algorithm that involves keeping the dimensionless (or Ec) in dimensioned values. For example:

Variable current rectifier: required to adjust the rate of reduction of Cu⁺² according to the Ec or [symbol] setting required. The capacity of the rectifier defines a maximum current and as control elements, a low voltage warning current of Cu⁺² and a minimum operating current are defined.

Equipment for variable feed flow: equipment is required to measure and regulate the flow of electrolyte feed to each cell, according to the signals of the Ec sensors. The characteristics of these equipment define the maximum and minimum flows of recirculation, both conditions that allow to narrow the operating amplitude of the proposed methodology. As a suggestion, the linear speed of the electrolyte over the cathodic surface should not exceed 12 cm/s.

Control PLC: that from Ec signals, flows, current and concentration of Cu² accordingly, act by defining electrolyte feed flows and feed currents for the rectifier, adjusting dynamically the range of operational Ec or [symbol] . Eventually, define actions associated with initiating or stopping electrolyte charge rich in Cu⁺², turn on warning alarms for overload or absence of Cu⁺².

Ec Sensors: In case of implementing the methodology by means of Ec readings, continuous operation sensors must be installed in each cell of the circuit.

Cu⁺² sensors: In case of implementing the methodology by means of [symbol] , a continuous operation Cu⁺² sensor must be installed in the feed flow to the cells.

Flow sensors: In case of implementing the methodology by means of [symbol] , flow sensors must be installed in the circuit cells.

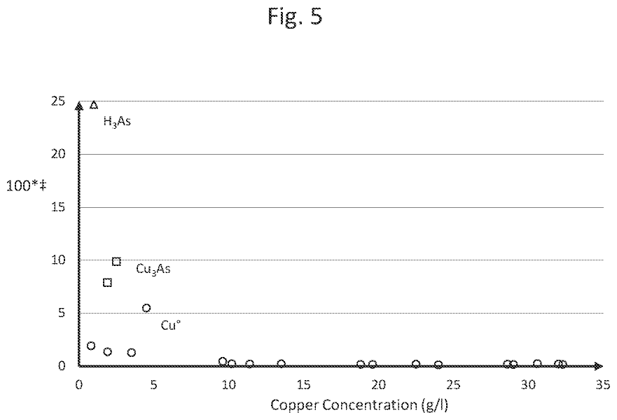

2.—Operation in the presence of Arsenic and [symbol] : FIG. 5 is constructed when considering plant data and reported in the bibliography. As ordinates, the value of 100* [symbol] was exposed, so as to obtain a percentage data of the reduced Cu versus the Cu fed to the anode-cathode interface per unit of time. It is observed that for dilute solutions of Cu⁺², the possibility of obtaining Cu⁰ in the cathode is restricted to a maximum extraction of approximately 6.5% of the Cu⁺² fed to the mentioned interface ( [symbol] maximum). This value decreases for solutions with concentration of Cu⁺² less than 5 gpl, and the condition must be studied on a case-by-case basis. In addition, it is observed that as the values of [symbol] increase, the cathode deposit can be cupro-arsenical solids and even arsine can be generated.

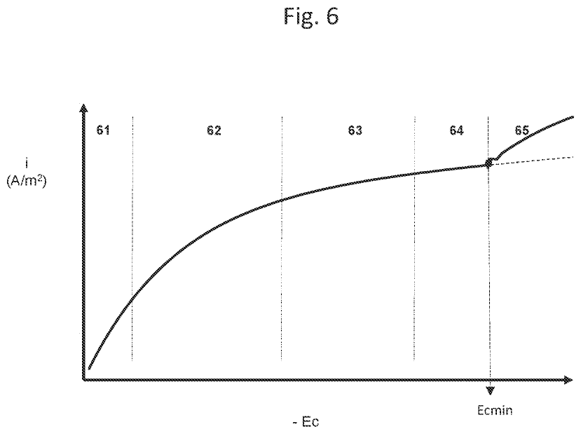

3.—Operation in the presence of Arsenic and Ec: When operating in the condition of extracting Cu⁰, the condition of higher productivity implies the controlled polarization of the process, up to the value indicated as Ecmin in FIG. 6. The range of cathode potentials (Ec) to be used (zone 64) varies with the current fed to the circuit, the concentration of As⁺³ and the temperature of the electrolyte, and the optimal condition for each particular application must be studied.

In the case of direct treatment of sulphuric polymetallic solutions at room temperature, with concentration of Cu⁺² less than 10 gpl, it is observed that the values of Ec (referring to Cu/Cu⁺²) estimated minimums are:

| Concentration of Cu⁺² | Ecmin (mV) |
|---|---|
| 1 | −286 |
| 2 | −317 |
| 5 | −370 |
| 10 | −432 |

The indicated values were obtained at laboratory level, with a concentration of As⁺^{³} of 1.3 g/l, without the use of additives; the use of lower Ec values resulted in the reaction of codeposition of As⁺^{³}, forming cupro-arsenic solids of type Cu₃As (FIG. 6, zone 65). The absence of As⁺^{³} (or concentrations less than 0.3 g/l), allows the use of potential cathodic lower than those indicated in the table, which is achieved by increasing the current of the circuit, that is, increasing its productivity; the use of higher temperatures increases ion mobility and minimum cathodic potentials. In an industrial implement, this curve must be known, in terms of current fed to cell v/s Ec minimum (or [symbol] maximum), because the stability of reactions and phenomena that occur on the cathodic surface must be maintained.

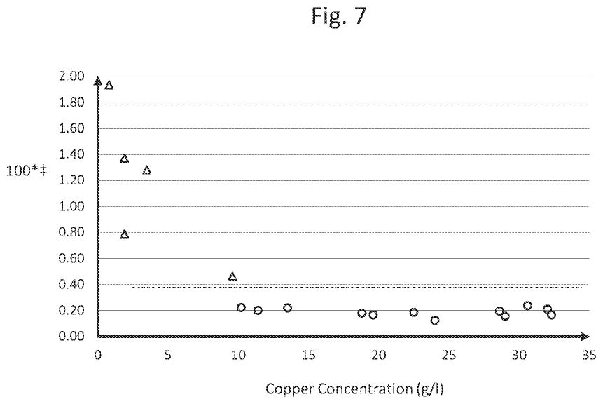

4.—Operation aimed at obtaining high purity cathodes: to obtain high purity cathodes, lower polarizations must be used, which implies the following options:
a) Control via [symbol] FIG. 7 shows the results obtained in the operation of a circular cell and current densities less than 800 A/m². It is observed that the use of values of 100* [symbol] above 0.4 results in the obtaining of contaminated cathodes (label Δ) and that for values of 100* [symbol] less than 0.25 grade A cathodes (label O) are obtained. The operation then assumes defining [symbol] in a range between 0.0020 and 0.0025, with the restriction of a maximum current density i of 800 A/m². The use of values of [symbol] greater than 0.0025 and less than 0.0040 should be studied for each particular installation.
b) Control via Ec: FIG. 6 shows the Ec v/s i curve with different operating zones that define different cathodic qualities:
   Zone 61: Formation de Cu⁰; dendritic deposits and electrolyte entrapment problems; efficient use of electrical energy fed to the circuit, but inefficient use of facilities; electrodes do not ensure quality, you must operate with lower Ec.
   Zone 62: Formation of high purity Cu⁰ in conventional circuits with rectangular cells and in circuits with circular cells.
   Zone 63: Formation of high purity Cu⁰ in circular cells; Cu⁰ to refining in conventional rectangular cells.
   Zone 64: Cu⁰ formation to refining in circular cells and in conventional cells.
   Zone 65: Formation of cupro-arsenical solids, of type Cu₃As.
   The cells must be equipped with Ec sensors, whose readings are defined in a range within 62 for conventional cells and within 63 for circular type cells.

On the other hand, the use of electrolyte flows that mean an average speed over the cathode between 0.5 and 12 cm/s is proposed in circular type cells. In conventional cells, ideally equipped with electrolyte channelers, the values may be lower. The ranges are referential and should be studied in consideration of each particular installation.

5.—In line operation without flow control: In case of installing one or more cells in the passage of a discard electrolyte current (acid drains, mine water, relay percolates, etc.) or, for example, in the feeding of leaching batteries, the design of the cells should be made in order to promote the highest linear speed of the electrolyte over the cathodes, hopefully, close to 12 cm/s, equipped with sensors that depend on the option to implement:
a) Control [symbol] contemplates the implementation of a Cu⁺² concentration sensor in the global feed current and electrolyte flow sensors that feed each cell; the operation is due to the setting of [symbol] , which involves analyzing the flow of Cu⁺² that is fed to the cell (product F*[Cu]i), which as it increases implies upward corrections of the fed current and analogously, as it decreases, the current of the rectifier decreases.
b) Control via Ec: Ec sensors are installed in each cell; Ec signals will increase their value with concentration increases of Cu⁺² and/or electrolyte flow and analogously, decrease their value by decreasing the concentration of Cu⁺² and/or electrolyte flow. Adjustments will be made only to the rectifier operation, which will increase or decrease the feed current in response to respective Ec elevations or descents outside the predefined operating range.

The rectifier shall be sized according to the highest concentration of Cu⁺² condition that may be presented in the electrolyte, associated with the highest expected flow rate.

6.—Operation at constant current and variable and controlled electrolyte flow: If constant productivity is required, operational options are:
a) Control via [symbol] : since i is fixed, corrections will be made in order to maintain the flow of Cu⁺² (product F*[Cu]i) within the range of authorized variations for [symbol] ; then the electrolyte flow will increase in the measure that the [Cu]i decreases, and analogously, the electrolyte flow will decrease in the measure that the [Cu]i increases. Another option is to feed the circuit with a parallel current of electrolyte charged in Cu⁺² so as to vary both F and [Cu]i.
b) Control via Ec: Ec sensors are installed in the cells, which will deliver signals downward in case of decreasing the concentration of Cu⁺² and upwards when it increases. Corrections will be to increase electrolyte flow when Ec decreases and decrease it when Ec increases, always keeping Ec within the predefined operational range. There is also the option to feed the circuit with a parallel current of electrolyte charged in Cu⁺², so as to increase Ec.

The cells should be designed in conjunction with the electrolyte recirculation system, so as to achieve a maximum surface velocity of the order of 7-12 cm/s. Upon reaching the maximum recirculation speed, the electrolyte exchange should be started by another with a higher concentration of Cu⁺².

7.—Refinement of Cu⁰ Anodes: in cathodic terms, the operation is perfectly analogous to that described in point 4. The difference is found in the anodic operation, where the installation of a physical-type barrier that prevents migration of particles of anodic mud to the cathode and equipment that allows the collection of the mentioned anodic muds must be considered.

8.—Operation oriented to co-extract arsenic: since the ΔG has a direct relationship with Ec, it also has it with the definition of [symbol] For the Ec, the attached table shows operating ranges for co-extraction of As, using the forming of cupro-arsenic solids

| Concentration of | Ecmax | Ec min |
|---|---|---|
| Cu⁺² | (mV) | (mV) |
| 1 | −290 | −450 |
| 2 | −325 | −490 |
| 5 | −375 | — |
| 10 | −440 | — |

For [symbol] , by defining the range between 0.065 and 0.12 cupro-arsenic solids are obtained in the cathode by inhibiting the forming of Arsine.

The operational ranges delivered are referential; the formation of cupro-arsenic solids is dependent on the partial concentrations of Cu and As and on the proportion Of Cu/As in the electrolyte.

It is very difficult to obtain Arsine in the presence of Cu concentrations greater than 4 (g/l), so Ecmin values are omitted for Copper concentrations greater than 4 (g/l). In solutions with concentrations of Cu less than 2 (g/l), the formation of Arsine was observed for Ec values less than −520 mV/Cu—Cu⁺².

For the co-extraction of Cu and As it is recommended to use a process with dual control, in which an operational range of [symbol] is set, restricted to a condition of Ec values greater than −500 mV/Cu—Cu⁺².

### CITATIONS

1: “Profile of the refractive index in the cathodic diffusion layer of an electrolyte containing CuSO₄ and H₂SO₄,” Yasuhiro Awakura and others, J. Electrochem. Soc., 1977, Vol 124, No. 7, pp 1050-1057, IP 130.203.136.75
2: U.S. Pat. No. 4,217,189, “Method and Apparatus for control of electro-winning of Zinc,” Robert C. Kerby, Aug. 12, 1980.
3: Seminario Inovación Codelco: presentación “Automatización de la operación en un circuito de descobrización total,” Alejo Gallegos, https://www.codelco.com/flipbook/innovacion/codelcodigital4/b9sl.pdf
4: “Laboratory and Pilot Scale Tests of a New Potential-Controlled Method of Copper Industrial Electrolysis,” Przemyslaw Los and others, J. Electrochem. Soc., 2014, 161(10) D593-D599
5: U.S. Pat. No. 5,529,672, “Mineral Recovery Apparatus,” Neal Barr et all, Jun. 25, 1996.
6: “Electro Obtención de Cobre a alta densidad de corriente,” R. Dixon et al, Proceedings of the III International Copper Hydrometallurgy Workshop, 2005, pp 491-499.

1. A process of electrochemical reduction of Cu⁺² and other metals, such as Ni, Ag, As, and Co, which controls migratory, diffusive and convective variables, allowing the extraction of Cu⁰ from dilute solutions and in the presence of other ions, CHARACTERIZED because it operates maintaining the cathode potential Ec or the recovery [symbol] within a predefined range. To prevent the Ec from exceeding the limits of a certain range, the flow of cupric ions should be increased or decreased, and the density of the current fed should be decreased or increased. To prevent the [symbol] from exceeding the limits of a certain range, the flow of cupric ions should increased or decreased, and the density of the current fed should be decreased or increased.

2. An electrolytic process according to claim 1, CHARACTERIZED because depending on the operational range of Ec or [symbol] that is selected, it can be used in the extraction of high purity Cu⁰, Cu⁰ to refining, As and Cu by means of the formation of cupro-arsenicals, or extracting As by the formation of Arsine.

3. A process according to claim 1, CHARACTERIZED in that it is equipped with Ec sensor (s), sensors of the flow fed to the cells, and equipment that allows the feeding flows to the cells to be varied, based on the Ec readings. The maximum feed flows to be used assume the achievement of electrolyte surface velocities of 12 to 20 cm/s at the cathodic surface; these values are referential since they depend on the hydrodynamics and accessory equipment of each particular installation.

4. A process according to claim 1, CHARACTERIZED because it is equipped with Cu⁺² concentration sensor (s), sensors of the flow fed to the cells, and equipment that allows varying feed flows, based on estimates of [symbol] The maximum feed flows to be used assume the achievement of electrolyte surface velocities of 12 to 20 cm/s at the cathodic surface; these values are referential since they depend on the hydrodynamics and accessory equipment of each particular installation.

5. A process according to claim 1, CHARACTERIZED in that it is equipped with a current rectifier that allows the current su lied to the circuit to be varied, based on the Ec readings or the value of [symbol] The maximum current to be considered assumes the achievement of an effective cathodic current density of 1000 A/m², a value that is referential as it will depend on the conditions of the particular equipment existing in each industrial installation (cells, busbars, types of connection to electrodes, etc.)

6. A process according to claim 1, CHARACTERIZED because when using the flow of electrolyte, the correction of Ec to higher values is carried out by increasing the flow fed to the cells.

7. A process according to claim 1, CHARACTERIZED because when using the flow of electrolyte, the correction of Ec to lower values is carried out by decreasing the flow fed to the cells.

8. A process according to claim 1, CHARACTERIZED because when using the flow of electrolyte, the correction of [symbol] to higher values is carried out by decreasing the volumetric flow fed to the cells.

9. A process according to claim 1, CHARACTERIZED in that when using the electrolyte flow, the correction of [symbol] to lower values is carried out by increasing the volumetric flow fed to the cells.

10. A process according to claim 1, CHARACTERIZED in that when using the current fed to the cells, the correction of Ec to higher values is carried out by decreasing the current fed to the rectifier.

11. A process according to claim 1, CHARACTERIZED in that when using the current fed to the cells, the correction of Ec to lower values is carried out by increasing the current fed to the rectifier.

12. A process according to claim 1, CHARACTERIZED in that when using the current fed to the cells, the correction of [symbol] to higher values is carried out by increasing the current fed to the rectifier.

13. A process according to claim 1, CHARACTERIZED in that when using the current fed to the cells, the correction of [symbol] to lower values is carried out by decreasing the current fed to the rectifier.

14. A process according to claim 1, CHARACTERIZED in that as the concentration of Cu⁺² decreases, increases in electrolyte flow are prioritized maintaining the current fed at its maximum or higher values with respect to the maximum capacity of the rectifier.

15. A process according to claim 1, CHARACTERIZED in that as the concentration of Cu⁺² increases, increases in the current fed by the rectifier are prioritized, maintaining the recirculation flow at its maximum or medium high values regarding maximum recirculation capacity.

16. A process according to claim 2, CHARACTERIZED because when used in recovering Cu⁰ in the presence of dissolved Arsenic, the minimum authorized operative Ec value is equal to or greater than the Ec value associated with the initiation of the formation of cupro-arsenical solids, of the Cu₃As type. This implies a dynamic adjustment of the range of Ec operative, as a function of the readings of the electric current fed to the circuit, the Arsenic concentration and/or the concentration of Cu⁺² in the electrolyte.

17. A process according to claim 2, CHARACTERIZED because when used in recovering Cu⁰ in the presence of dissolved Arsenic, the value of [symbol] maximum authorized operative implies recovering up to 6.5% of the Cu⁺² fed to the anode-cathode interface.

18. A process according to claim 2, CHARACTERIZED because when used to form Cu⁰ and cupro-arsenical solids of the Cu₃As type, it uses Ec values greater than −500 mV/Cu—Cu⁺².

19. A process according to claim 2, CHARACTERIZED because when used in forming Cu⁰ and solids of the Cu₃As type, uses values of [symbol] which imply recovering between 5% and 12.5% of the Cu⁺² fed to the anode-cathode interface; recommends complementary use of Ec sensors in order to maintain the Ec signal at values not less than −500 mV/Cu—Cu⁺², which allow to ensure the non-generation of Arsine, making the process safe.

20. A process according to claim 2, CHARACTERIZED because when used to form Cu⁰ grade A, it uses Ec values greater than −250 mV/Cu—Cu⁺².

21. A process according to claim 2, CHARACTERIZED because when used to form Cu⁰ grade A, it uses values of [symbol] which imply recovering up to 0.50% of the Cu⁺² fed to the anode-cathode interface.
